(19) United States
(12) Patent Application Publication
(10) Pub. No.: US 2012/0037047 A1
(43) Pub. Date: Feb. 16, 2012

(54) Foldable Laptop Stand

(76) Inventor: Marius Moldovan, Targu Mures (RO)

(21) Appl. No.: 12/854,349

(22) Filed: Aug. 11, 2010

(51) Int. Cl. F16M 11/38; H01F 7/00

(52) U.S. Cl. 108/3

(57) ABSTRACT

A foldable laptop stand includes a laptop support surface with a first portion and a second portion, where the first portion and the second portion are non-co-planer. A support surface angle positioner is coupled to and co-planer with the first portion of the laptop support surface. A positioner engagement portion is coupled to and co-planer with the second portion of the laptop support surface. In addition, the support surface angle positioner and the first portion of the laptop support surface have a first hinged interface therebetween, the positioner engagement portion and the second portion of the laptop support surface have a second hinged interface therebetween, and the positioner engagement portion is removably coupleable with the support surface angle positioner to selectably position the laptop support surface at an angle to the support surface angle positioner.

### FIELD OF THE INVENTION

The present invention relates generally to laptop stands, and, more particularly, relates to an ultrathin foldable laptop stand that can be coupled to a bottom surface of the laptop computer and easily deployed to support the laptop above a support surface.

### BACKGROUND OF THE INVENTION

Over the past 10 years, laptop-sized computers have become ubiquitous. This is due, at least in part, to the fact that laptop-sized computers provide the same computing power as a larger desktop computer in a fraction of the size. This size/performance factor conveniently allows the user to have a full-featured computer at their fingertips at all times.

Smaller size, however, brings with it certain drawbacks. For one, most laptop keyboards are smaller than standard desktop keyboards and are difficult to use for people with normal or larger than normal hands. In addition, laptop keyboards often include a mouse device, such as a touchpad or track button. Having the mouse device on the small keyboard makes using a laptop keyboard even more difficult, as a user is prone to inadvertently touching the touchpad while typing. For this reason, some users prefer to attach a standard keyboard to their laptop computer before performing extensive typing tasks.

In addition, when placed on a standard work surface, such as a desk, the laptop screen is at a height much lower than that of a standard desktop video monitor. This lower height causes strain on the neck of a user, who naturally tends to bend down to see the screen. If the laptop screen is tilted towards the users face, there can be a distracting glare on the screen caused by above-head lighting. In addition, tilting the screen moves the image even further away from the user's eyes.

To solve the problem of the laptop screens being distanced from the user's eyes, many manufacturers have provided laptop stands that elevate the laptop computer from the work surface and move it closer to the user's face. This improved position not only improves the ergonomic posture of a user, it also reduces glare on the screen.

One such device is the laptop stand 100 shown in FIG. 1. The laptop stand 100 elevates and supports a laptop 102 from a surface 106. In particular, the laptop stand 100 supports the keyboard portion 104 of the laptop 102 and holds it in a position that is substantially parallel to the surface 106 from which it is being supported. The main drawback of this model is the lack of portability as it does not fold.

Another prior-art laptop support device is shown in FIG. 2. The laptop stand 200 supports a laptop computer 202. In particular, a support portion 201 of the laptop stand 200 supports the keyboard portion 204 of the laptop computer 202 at an angle to the support surface 206. The laptop stand 200 advantageously raises the screen 208 of the laptop computer 202 off of the surface 206. However, because the laptop computer 202 simply rests on the laptop stand 200, the angle of the laptop stand 200 provides an unstable holder of the laptop computer 202.

Angular laptop stands, such as that shown in FIG. 2, rely on the principle of “concave nesting” to hold the laptop in an elevated position. “Concave nesting” means that the laptop is retained in a predefined space by means of levers, prop ups (e.g., lip 210) that restrain the laptop computer 202 from falling/slipping toward the surface 206 of the table upon which it is being supported. A significant disadvantage of this design is its lack of portability, i.e., it is difficult to fold. In addition, it requires setup time and effort, which decreases much of the user friendliness of the stand. Moreover, the stand has several moving parts, making it prone to mechanical failure

Other known angular laptop stands, as shown in FIG. 3, rely on friction 302 to prevent the laptop computer 202 from sliding off of the laptop stand 300 onto the surface 206. The friction 302 can be a frictional force resulting from an interaction between, for example, rubber feet and the support surface area 301. Other known laptop stand devices utilize VELCRO-like fasteners as a way of securing the laptop computer 202 to the laptop stand.

The connection between the laptop stand and the laptop is, therefore, limited to levers 210 and friction 301 and the laptop stand has no other interconnection with the laptop computer 202. When a laptop computer 202 and/or laptop stand 100, 200, 300 is accidentally bumped or otherwise moved, the frictional force can be overcome and the laptop computer 202 can become separate from the laptop stand 100, 200, 300.

In addition, when a user changes his/her location of work (very typical for a laptop user), he/she has to pack and carry the laptop and the laptop stand separately. This is inconvenient, time-consuming, and can often result in loss or purposeful failure to bring the laptop stand. Therefore, because the user ceases use of laptop stand, all ergonomic benefit of the laptop stand is lost.

Therefore, a need exists to overcome the problems with the prior art as discussed above.

### SUMMARY OF THE INVENTION

The invention provides a foldable laptop stand that overcomes the hereinafore-mentioned disadvantages of the heretofore-known devices and methods of this general type and that securely couples to an underside surface of a laptop computer, while providing a very low profile structure when folded.

With the foregoing and other objects in view, there is provided, in accordance with the invention, a foldable laptop stand that includes a laptop support surface with a first portion and a second portion, where the first portion and the second portion are non-co-planer. A support surface angle positioner is coupled to and co-planer with the first portion of the laptop support surface. A positioner engagement portion is coupled to and co-planer with the second portion of the laptop support surface. In addition, the support surface angle positioner and the first portion of the laptop support surface have a first hinged interface therebetween, the positioner engagement portion and the second portion of the laptop support surface have a second hinged interface therebetween, and the positioner engagement portion is removably coupleable with the support surface angle positioner to selectably position the laptop support surface at an angle to the support surface angle positioner

In accordance with another feature of the present invention, the support surface angle positioner defines at least one receiving area therein, the at least one receiving area shaped to engage an end of the positioner engagement portion.

In accordance with a further feature of the present invention, the first portion and the second portion of the laptop support surface are coupled to each other in a fixed positional relationship.

In accordance with an additional feature of the present invention, the second portion of the laptop support surface defines at least one aperture shaped to accept a laptop stand securing anchor coupled to a bottom surface of a laptop.

In accordance with another feature of the present invention, the support surface angle positioner and the first portion of the laptop support surface include a first solid planar layer; a sheet of flexible material disposed on top of at least a portion of the first solid planar layer; and a second solid planar layer disposed on an opposing side of the sheet of flexible material as the first solid planar layer.

In accordance with a further feature of the present invention, the first hinged interface includes an exposed area of the flexible material coupled to the support surface angle positioner, the exposed area being of sufficient size to place the flexible material in contact with a supporting surface when at least one of the first hinged interface and the second hinged interface are in a bent configuration.

In accordance with another feature, an embodiment of the present invention includes a first magnet portion coupled to the second portion of the laptop support surface and a second magnet portion coupled to the support surface angle positioner, wherein the first magnet portion and the second magnet portion display a magnetic attraction toward one another.

In accordance with another feature, an embodiment of the present invention also includes a configurable laptop stand for use with a laptop computer having an outer case, the laptop stand including at least one laptop-stand anchor coupled to an underside of the laptop computer case, a laptop support surface defining at least one aperture shaped to selectively engage the laptop stand with the laptop computer case, a laptop angle positioner hingedly coupled to the laptop support surface, a positioner engagement portion hingedly coupled to the laptop support surface, and a laptop angle positioner securing mechanism operable to bias the laptop angle positioner in a position parallel to the laptop support surface.

In accordance with yet another feature, an embodiment of the present invention includes a configurable laptop stand for use with a laptop computer having a keyboard and an outer case, the laptop stand including at least one laptop-stand anchor at a surface of an outer case of the laptop computer, a laptop angle positioner defining at least one aperture shaped to selectively engage with the at least one laptop-stand anchor, and a positioner engagement portion defining at least one aperture shaped to selectively engage with the at least one laptop-stand anchor, wherein the positioner engagement portion is removably coupleable with the laptop angle positioner to selectably position the laptop angle positioner at an angle to the positioner engagement portion.

In accordance with a further feature, the present invention includes a laptop angle positioner securing member operable to secure the laptop angle positioner in a position that is parallel to a surface of a laptop keyboard.

In accordance with an additional feature, the laptop angle positioner securing member is operable to bias the positioner engagement portion in a position that is parallel to the laptop keyboard portion.

Although the invention is illustrated and described herein as embodied in a foldable laptop stand, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a side elevational view of a prior-art laptop stand supporting a laptop computer;

FIG. 2 is a side elevational view of a prior-art laptop stand supporting a laptop computer;

FIG. 3 is a side elevational view of a prior-art laptop stand supporting a laptop computer;

FIG. 4 is a perspective side view of a foldable laptop stand in a deployed configuration in accordance with an exemplary embodiment of the present invention;

FIG. 5 is a perspective underside back-side view of the foldable laptop stand of FIG. 4 in a deployed configuration in accordance with an exemplary embodiment of the present invention;

FIG. 6 is a perspective downward back-side view of the foldable laptop stand of FIG. 4 in a deployed configuration in accordance with an exemplary embodiment of the present invention;

FIG. 7 is a perspective side view of the foldable laptop stand of FIG. 4 in a folded configuration in accordance with an exemplary embodiment of the present invention;

FIG. 8 is an elevational edge view of a portion of three-layer material forming a structural portion of a foldable laptop stand, including a hinged interface, in accordance with an exemplary embodiment of the present invention;

FIG. 9 is an elevational edge view of the three-layer material of FIG. 8 showing the hinged interface in a bent position in accordance with an exemplary embodiment of the present invention;

FIG. 10 is an elevational side view of a foldable laptop stand in a deployed configuration below a laptop computer provided with a first type of securing shoulder features in accordance with an exemplary embodiment of the present invention;

FIG. 11 is an elevational side view of a foldable laptop stand in a deployed configuration below a laptop computer provided with a second type of securing shoulder features in accordance with an exemplary embodiment of the present invention;

FIG. 12 is an planar top view of a foldable laptop stand with apertures in a folded configuration in accordance with an exemplary embodiment of the present invention;

FIG. 13 is an elevational side view of a laptop support surface of a foldable laptop stand in a flexed configuration being installed between securing shoulders coupled to a laptop computer in accordance with an exemplary embodiment of the present invention;

FIG. 14 is an elevational side view of a foldable laptop stand in a deployed configuration below a laptop computer provided with a securing shoulder features in close proximity in accordance with an exemplary embodiment of the present invention; and

FIG. 15 is a planar top view of a foldable laptop stand with apertures, the foldable laptop stand being in a folded configuration in accordance with an exemplary embodiment of the present invention.

FIG. 16 is a planar top view of a foldable laptop stand with apertures, the foldable laptop stand being in a folded configuration in accordance with an exemplary embodiment of the present invention.

FIG. 17 is an elevational side view of a foldable laptop stand in a deployed configuration below a laptop computer provided in accordance with an exemplary embodiment of the present invention.

FIG. 18 is an elevational side view of a foldable laptop stand integrated with an outer case of a laptop computer in accordance with an exemplary embodiment of the present invention.

FIG. 19 is an elevational side view of a foldable laptop stand with a document support surface in a deployed configuration in accordance with an exemplary embodiment of the present invention.

FIG. 20 is an elevational side view of a foldable laptop stand with a document support surface in a partially deployed configuration in accordance with an exemplary embodiment of the present invention.

FIG. 21 is an elevational side view of a foldable laptop stand with a document support surface in a partially collapsed configuration in accordance with an exemplary embodiment of the present invention.

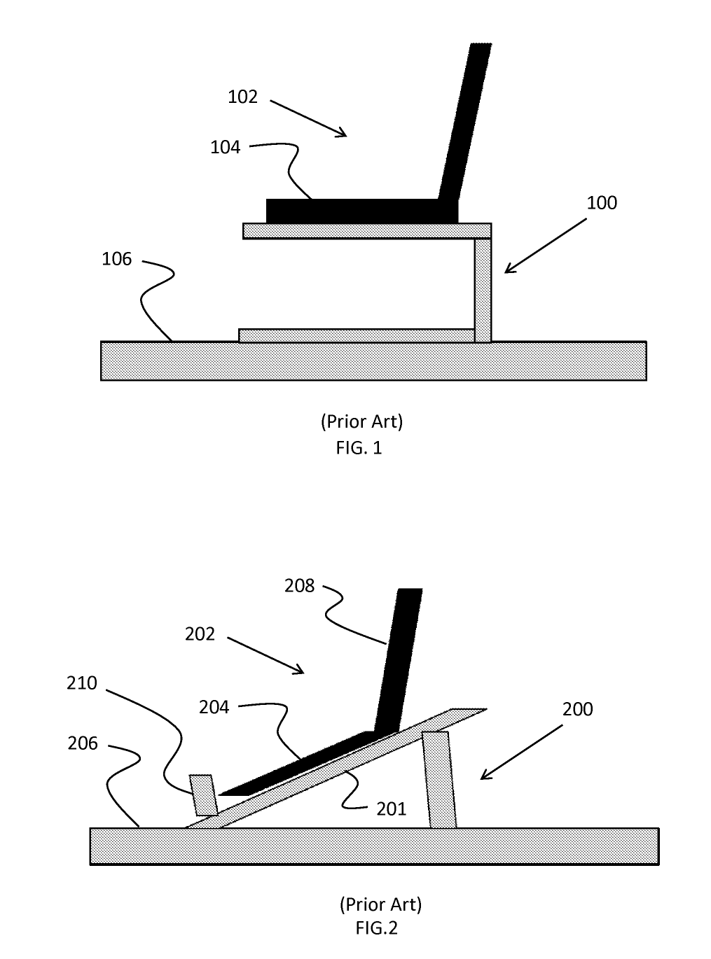

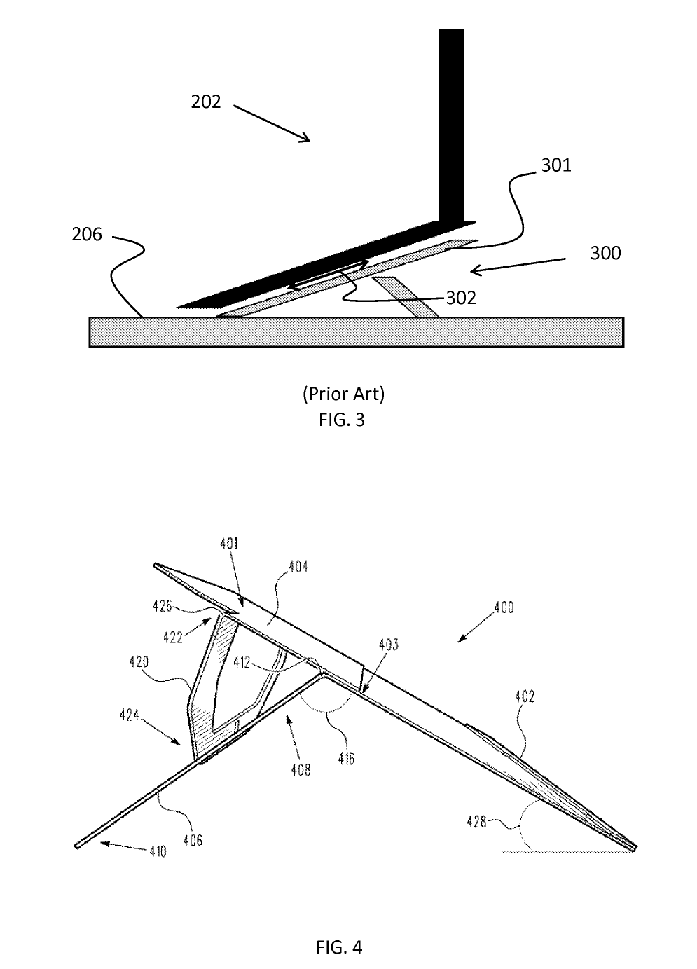

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel, light weight, and efficient laptop stand suitable for quick and easy deployment resulting in the secure elevation of a laptop computer. Embodiments of the invention provide the inventive laptop stand in a form that easily folds into a low profile form factor that can be stored and transported. In addition, embodiments of the invention provide the inventive laptop stand in complimentary elements that easily removably couple to the underside of a laptop computer, providing rapid and simple deployment.

Referring now to FIG. 4, one embodiment of the present invention is shown in a perspective side view. FIG. 4 shows several advantageous features of the present invention, but, as will be described below, the invention can be provided in several shapes, sizes, combinations of features and components, and varying numbers and functions of the components. The first example of a foldable laptop stand 400, as shown in FIG. 4, includes a laptop support surface 401. The laptop support surface 401 is the surface upon which the laptop computer will rest. In the particular embodiment shown in FIG. 4, the laptop support surface 401 is formed by a first portion 402 and a second portion 404. The elevational side view of FIG. 4 shows that the first portion 402 makes contact with a surface 414 and is in a different plane than the second portion 404, which is coupled directly onto the first portion 402. That is, the first portion 402 and the second portion 404 have an overlapping region 403 that places the first portion 402 and the second portion 404 in a fixed-position parallel relationship. There is, however, no requirement that the laptop support surface 401 be formed of two separate portions or that those two portions overlap one another.

The foldable laptop stand 400 also includes a support surface angle positioner 406. The support surface angle positioner 406 has a first end 408 and a second end 410, with the first end 408 being coupled to the first portion 402 of the laptop support surface 401 at an interface 412. The interface 412 is, according to an embodiment of the present invention, a hinged connection between the support surface angle positioner 406 and the first portion 402 of the laptop support surface 401. The hinged interface allows an angle 416 between the laptop support surface 401 and the support surface angle positioner 406 to be adjusted to one or more selectable values.

The second end 410 of the support surface angle positioner 406, when the foldable laptop stand 400 is unfolded, i.e., the angle 416 is less than 180°, contacts the surface 414 on which the laptop stand 400 is supported. With reference to FIG. 4, the lower the angle 416 becomes, the higher an angle 428, between the surface 414 and the laptop support surface 401, becomes. As explained below, selection and maintenance of the angle 428 is accomplished through use of the positioner engagement portion 420 of the laptop stand 400.

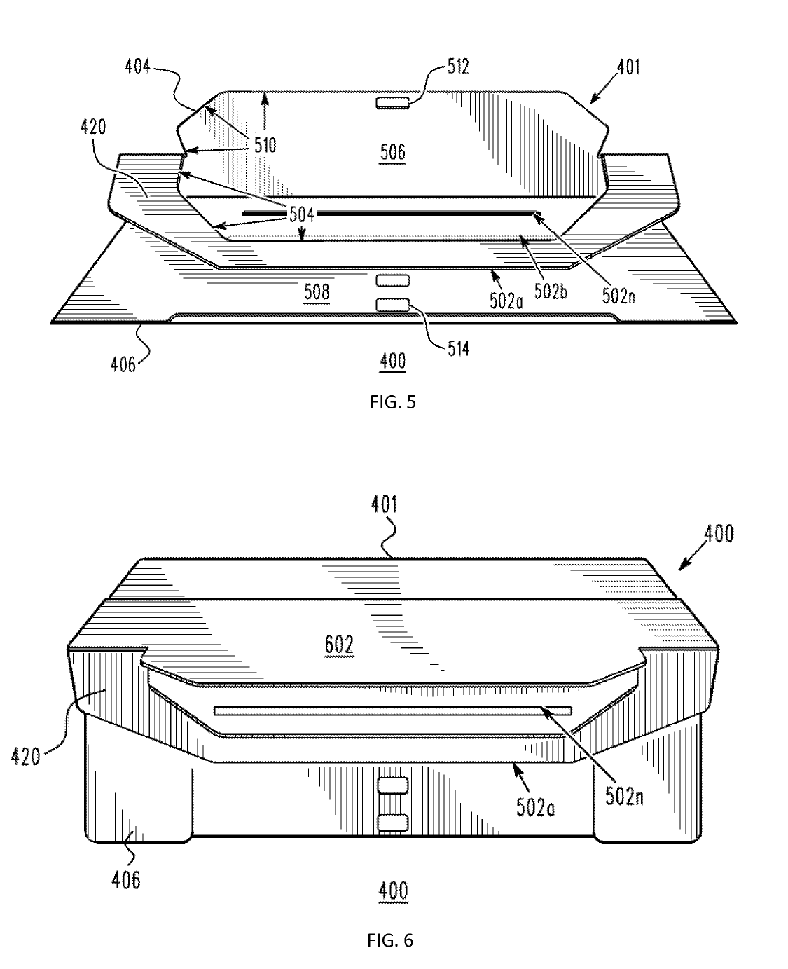

The positioner engagement portion 420 has a first end 422 and the second end 424, with the first end 422 being coupled to the second portion 404 of the laptop support surface 401 at an interface 426. The interface 426 is, according to an embodiment of the present invention, a hinged connection between the positioner engagement portion 420 and the second portion 404 of the laptop support surface 401. The hinged interface 426 allows the positioner engagement portion 420 to couple with the support surface angle positioner 406. By providing several coupling locations on the support surface angle positioner 406, the positioner engagement portion 420 allows an angle 428 between the laptop support surface 401 and the positioner engagement portion 420 to be adjusted to one or more selectable angular values. FIG. 4 shows the second end 424 of the positioner engagement portion 420 coupled to the support surface angle positioner 406 at one of these locations. This coupling, however, is better illustrated in elevational rear-facing views of FIGS. 5 and 6.

Referring first to FIG. 5, it can be seen that a portion of the positioner engagement portion 420 has been inserted within one of multiple receiving areas 502a-n (where n represents any number greater than one) formed within the support surface angle positioner 406. The receiving areas 502a-n can be any shape that allows the second end 424 of the positioner engagement portion 420 to physically couple with the support surface angle positioner 406. These shapes can include lines, holes, indentations, raised areas, and others.

Because the positioner engagement portion 420 is resting within the receiving area 502a in the embodiment of FIG. 5, the laptop support surface 401 remains propped up at an angle from the horizontal surface 414 upon which the laptop stand 400 rests. The angle of the laptop support surface 401, in the view of FIG. 5, renders the underside surface 506 of the laptop support surface 401 and an upper surface 508 of the support surface angle positioner 406 visible.

It should be noted that, in the embodiment of the present invention shown in FIG. 5, the positioner engagement portion 420 defines a shape 504 within its surface. In addition, an outer edge of the second portion 404 of the laptop support surface 401 defines a shape 510 that corresponds with the shape 504 defined by the support surface angle positioner 406. As will be shown in the following figures and explained below, the corresponding shapes 510 and 504 are able to mate with each other, advantageously allowing the present invention to collapse into a very thin form factor. Of course, there is no requirement that the mating between shapes 510 and 504 are close or that the shapes 510 and 504 be the same general shape. As long as the outer edge that forms shape 510 fits within the inner edge that forms shape 504, the present invention is able to collapse into a very thin form factor.

The elevational top rear view of the laptop stand 400 of FIG. 6 also shows the second end 424 of the positioner engagement portion 420 coupled with the first receiving area 502a of the angle positioner 406. In the particular view of FIG. 6, the upper surface 602 of the laptop support surface 401 is shown. It is this upper surface 602 that a laptop computer will rest upon when the laptop stand 400 is deployed.

The present invention, as described thus far, provides several advantages over prior art laptop stands. The unique design provides at least three important benefits: 1) only two layers are used to form the laptop support surface 401 and angle positioner 406, which provides minimal thickness and weight while offering superior strength and stability; 2) laptop stand 400 is easy to deploy, fold, and use by a user; and 3) the laptop stand 400 leaves sufficient locations for connection of the laptop stand 400 to a laptop computer. This is advantageous because the bottom surface of each laptop can vary from the bottom surface of other laptops. More specifically, laptop computers frequently feature uneven areas on their bottom surface as well as other elements, such as airflow grills, screws, feet, information-bearing stickers, and many others. Therefore, it is advantageous to provide as large of an area as possible to define the proper location of the connectors, such as VELCRO.

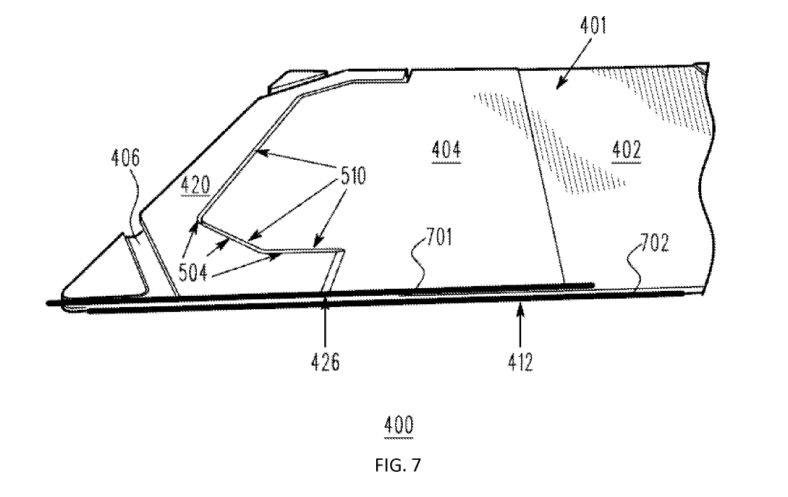

FIG. 7 provides an elevated edge view of the foldable laptop stand 400 in a collapsed state. Advantageously, the foldable laptop stand 400 is able to fold into a very thin form factor. This is due, in part, to the relationship of the structural components, as well as a selection of materials used to form each of the components. In the edge view of FIG. 7, it can be seen that, when compressed, the second portion 404 of the laptop support surface 401 and the positioner engagement portion 420 substantially share a single plane 701. This single plane 701 is shared when the second portion 404 of the laptop support surface 401 and the positioner engagement portion 420 pivot upon the interface 426 until the shape 504 defined within the positioner engagement portion 420 mates with the shape 510 defined by the outer edge of the second portion 404 of the laptop support surface 401.

The edge view of FIG. 7 also shows that the first portion 402 of the laptop support surface 401 and the support surface angle positioner 406 substantially share a second single plane 702 when the support surface angle positioner 406 pivots upon the interface 412 until it makes contact with a bottom surface of the second portion 404 of the laptop support surface 401.

In accordance with one embodiment of the present invention, the foldable laptop stand 400 is able to retain its collapsed state through the assistance of one or more magnet pairs 512, 514, shown in FIG. 5. By placing one half 512 of the magnet pair on, for instance, the second portion 404 of the laptop support surface 401 and the other half 514 on, for instance, the support surface angle positioner 406, the magnetic attraction of the two halves 512, 514 will provide a retaining force that will hold the stand 400 in its flattened state shown in FIG. 7. It should be noted however, that the exact positioning of the magnet pairs 512, 514 is not important for carrying out the present invention. Any position of the magnet pairs 512, 514 that allow the inventive laptop stand 400 to remain collapsed can be sufficient.

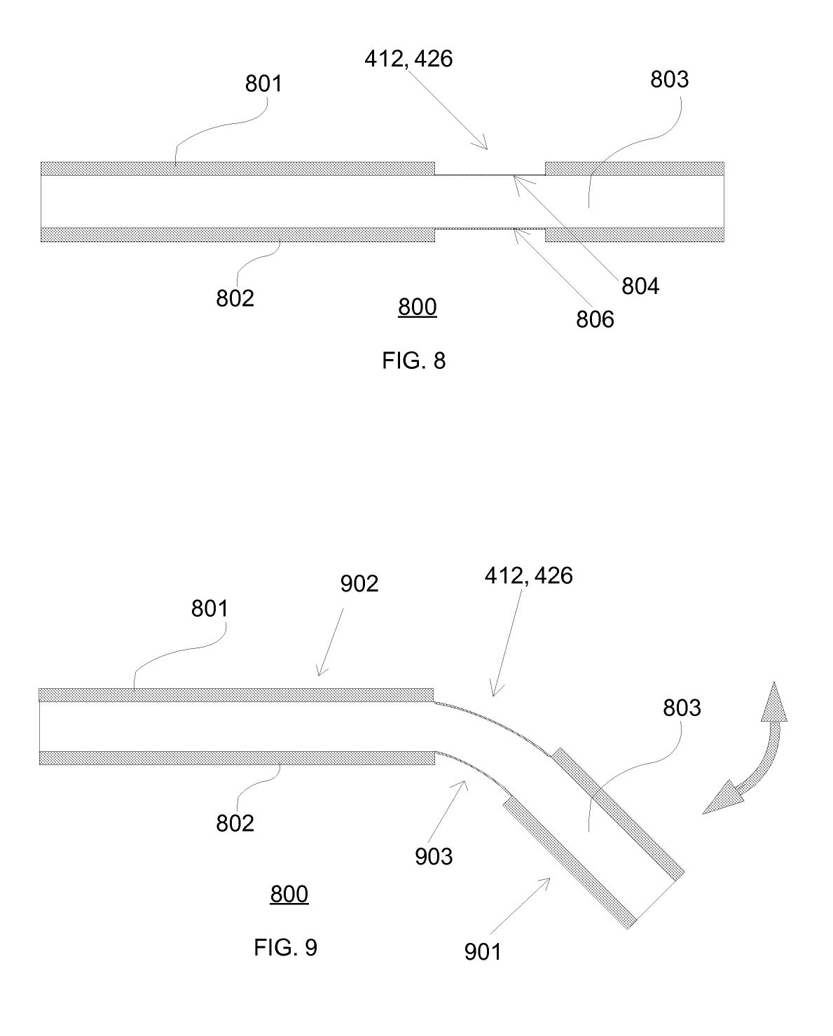

In accordance with an embodiment of the present invention, all or portions of the inventive laptop stand 401 are formed from material that provides solid surfaces as well as hinged interfaces between the aluminum surfaces. One exemplary commercially-available material is called aluminum composite panel (ACP), often sold under the trade name HYLITE, which is a laminate material formed from two thin layers of aluminum 801, 802 sandwiching a plastic layer 803 in between, all of which are shown in FIG. 8.

In this embodiment, areas of discontinuity 804, 806 are present in each of the aluminum layers 801, 802, respectively, thereby exposing the plastic layer 803 on two opposing sides thereof. As FIG. 8 shows, these two areas of discontinuity 804, 806 vertically coincide with one another to form the hinged interfaces 412, 426.

FIG. 9 shows how the plastic layer 803 allows a first portion 901 of the material 802 to bend with reference to a second portion 902 of the material 800. In accordance with an embodiment of the present invention, the first portion 901 of the material 800 can be folded back toward the second portion 902 further than what is shown in FIG. 9. As the interior angle between the first portion 901 and a second portion 902 decreases, more and more of the plastic material 803 is exposed on the outside of the bend. In some embodiments of the present invention, this exposed portion of the plastic material 803 can be used as “feet” for the stand. In other words, this flexible plastic shown in FIG. 9 can be the point of contact between the laptop stand 400 and the surface on which the laptop stand 400 is resting. One way of implementing this embodiment is to provide a third hinged interface on one of the elements, for example, on the support surface angle positioner 406 of the inventive laptop stand 400. In this embodiment, the third hinged interface 903 will allow the element supporting the third hinged interface to fold, for example, 180° back onto the element to expose the flexible material and allow it to serve as one or more protective feet. Even more specifically, this third hinged interface 903 can be provided near an extent of the support surface angle positioner 406 close to the support surface 414.

An exemplary thickness of each of the aluminum layers is about 0.2 mm and an exemplary thickness of the flexible plastic layer is about 0.8 mm Compared to a steel sheet and a solid aluminum sheet with the same flexural stiffness, ACP is approximately 65% and 30% lighter, respectively. This result has been obtained by uniting the best properties of aluminum and plastic in a single material (aluminum on the outside and a light plastic filling inside). In accordance with one embodiment of the present invention, the plastic material is Polypropylene. Materials such as Polypropylene can be flexed tens of thousands of times without noticeable degradation to the material. In alternative embodiments, alternative materials, such as high density polyethylene (HDPE), can be utilized. In addition, the aluminum sheets can be replaced with other materials such as hardened plastics, steel, or many others.

Of course, materials other than ACP can be used to form the elements of the presently inventive laptop stand 400. One such exemplary material is a plastic, e.g., polypropylene, sheet that is molded to the desired shape. The hinges 412, 426, in this embodiment, can be what are known as “living hinges” (similar to the popular cap closing attachment of a shampoo bottle) that can last for thousands of closing/opening cycles. Other plastics with similar properties can be uses as well, such as those produced by the DUPONT Corporation.

The outer aluminum layers of the ACP material lend themselves well to coloring and other special treatments. For example, the material can be anodized so that the raw aluminum becomes, for example, matt black or any other color. An advantage of this treatment is that the material becomes heavily scratch resistant.

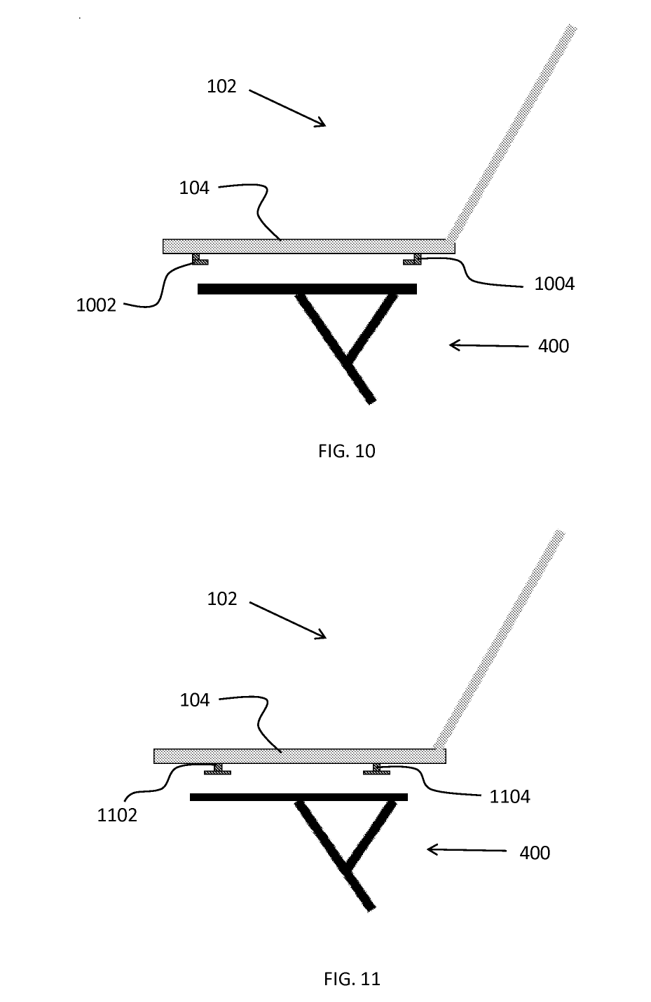

Accordance with a further embodiment, the present invention includes a connection to a laptop computer 102. The connection, can be accomplished in several different ways. For instance, FIG. 10 shows a laptop computer 102 with a pair of shoulders 1002, 1004 coupled to an underside surface of the laptop computer 102. The shoulders 1002, 1004 serve as anchors for securing the laptop stand 400 to the laptop computer 102 and can be molded directly into the underside of the case, which usually made of a plastic material, of the laptop computer 102 or can be the rubber feet provided on the underside of the laptop by the original equipment manufacturer. Alternatively, the shoulders 1002, 1004 can be separately secured in a removable or nonremovable manner to the laptop's case. In FIG. 10, the size of the shoulders 1002, 1004 are greatly exaggerated. In practice, however, the shoulders 1002, 1004 extend no further than standard rubber feet provided on most known laptop computers. The low-profile shoulders 1002, 1004, which do not extend past the rubber feet, allows the laptop computer 102 to be used without the laptop stand 400 with no detriment to the user. As a result, laptop manufacturers can freely provide shoulders, or other attachment locations/features, as a standard feature on their original equipment. Laptop purchasers will then have the option of purchasing/attaching the laptop stands if they choose.

FIG. 11 provides an elevational side view of a second embodiment of a pair of shoulders 1102, 1104. The shoulders 1102, 1104 of FIG. 11 have an inverted “T” shape. Of course, shoulder shapes other than those shown in FIGS. 10 & 11 can also be used. As with the shoulders 1002, 1004, the shoulders 1102, 1104 can be integral with. i.e., molded into, the plastic case of a laptop computer 102 or be separate pieces that are added to the laptop case later.

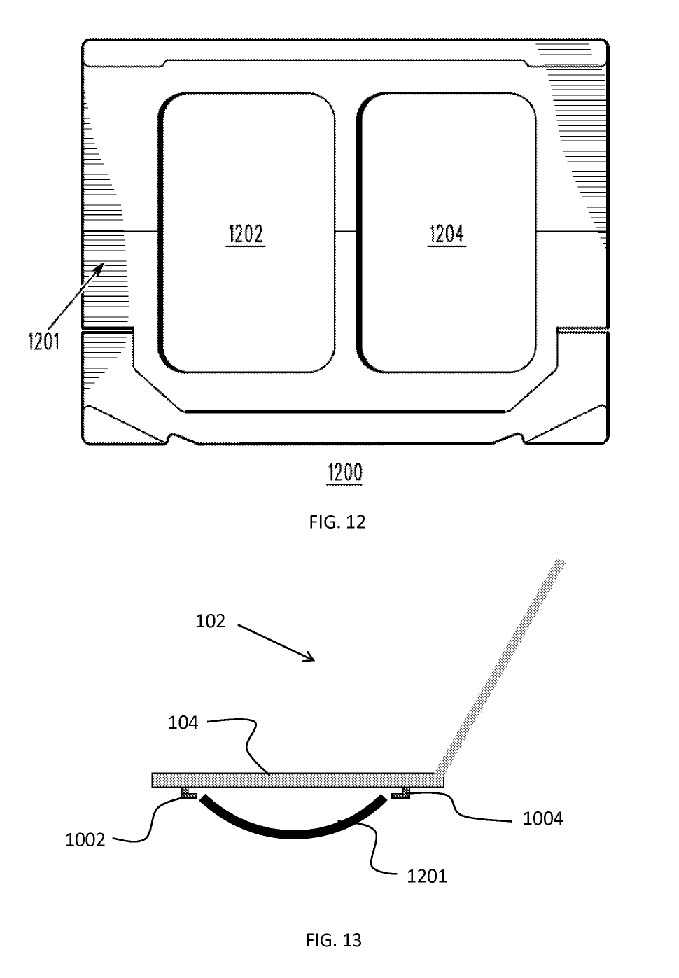

FIG. 12 shows an embodiment of the invention that facilitates connection to the shoulders 1002, 1004 shown in FIG. 10 or shoulders 1102, 1104 shown in FIG. 11. In this embodiment, a laptop support surface 1201 of a laptop stand 1200 defines a pair of apertures 1202, 1204 therein. The provision of the apertures 1202, 1204 serves to weaken the overall laptop support surface 1201, as less material is present. Weakening the laptop support surface 1201 is advantageous, as it allows the laptop support surface 1201 to be flexed somewhat easier than without the apertures 1202, 1204. Flexible materials (with high elastic deformation properties) such as ACP or other similar materials, behave very well when distorted and released.

FIG. 13 shows the laptop support surface 1201 being flexed to create a bent shape. By bending the laptop support surface 1201 in this way, the outer edges of the laptop support surface 1201 move toward one another and the laptop support surface 1201 is able to fit between the shoulders 1002, 1004. When the laptop support surface 1201 is unflexed, i.e., returns to its natural planar resting shape, tension will secure the laptop support surface 1201 between/to the shoulders 1002, 1004. This securing between the laptop support surface 1201 and the shoulders 1002, 1004 can result not only from this flexing, but also from sliding the laptop stand from a side of the laptop inward so the laptop support surface 1201 fits in between the shoulders 1002, 1004, stretching, or other locking mechanisms that produce the result of securing the laptop stand 1200 to the laptop computer 102.

In addition, the laptop stand 1200 can be used for attachment to the shoulders 1102, 1104 shown in FIG. 11. For attachment to shoulders 1102, 1104, the laptop support surface 1201 of the laptop stand 1200 is a flexed in a direction opposite to that shown in FIG. 13. When flexed in the opposite direction of FIG. 13 the apertures 1202, 1204 become slightly elongated or expand from the shape shown in FIG. 12. When the apertures 1202, 1204 are expanded they are able to fit over the T-shaped shoulders 1102, 1104. When the laptop support surface 1201 is allowed to return to its natural planer resting state, it traps the T-shaped shoulders 1102, 1104 within the apertures 1202, 1204 and secures the laptop stand 1200 to the laptop computer 102.

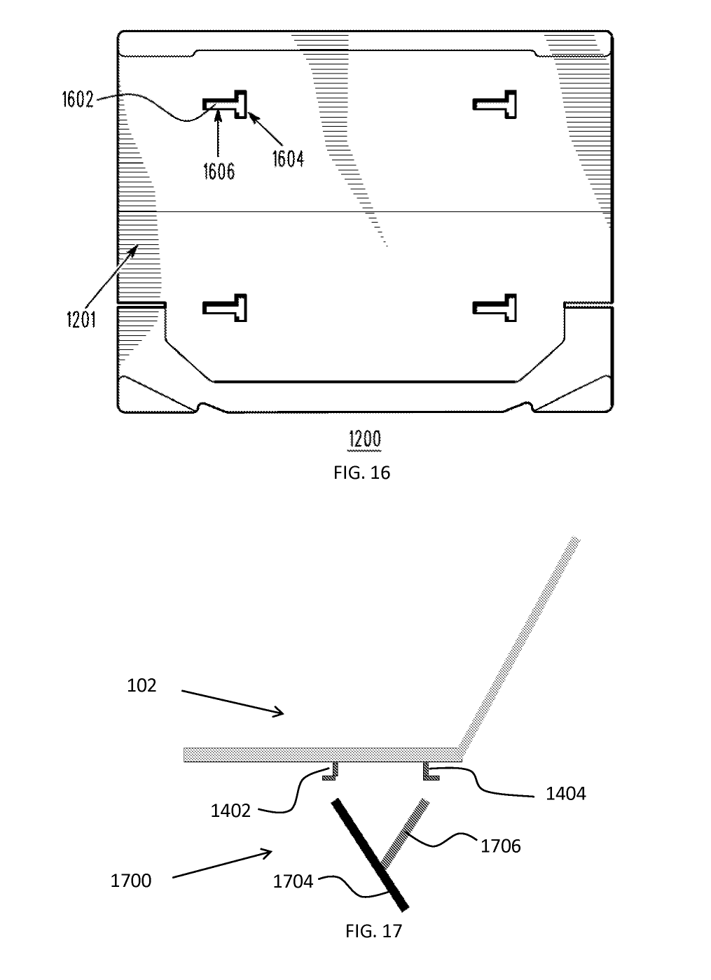

Furthermore, a plurality of slots 1602 can be provided on at least the laptop support surface 1201 of the laptop stand 1200, as shown in FIG. 16. For attachment to shoulders 1102, 1104, the laptop support surface 1201 is positioned underneath the laptop computer so that a first portion 1604 of the slots 1602 is aligned with the shoulders 1102, 1104. As shown in FIG. 16 the first portion 1604 of the slots 1602 has a dimension that is larger than a corresponding dimension of a second portion 1606 of the slots 1602. Once the shoulders 1102, 1104 are aligned with the shoulders 1102, 1104 are inserted through the first portion 1604 of each of the slots 1602. The laptop stand 1200 is then slid, with reference to the laptop computer, so that the shoulders 1102, 1104 are moved within the second portion 1606 of the slots 1602. Because the second portion 1606 of the slots 1602 have a smaller dimension than the first portion 1604 of the slots 1602, the shoulders 1102, 1104 are captured by the slots 1602.

Referring back to FIG. 12, the apertures 1202, 1204 provide the added advantage of facilitating cooling ventilation for the laptop computer 102. That is, because the apertures 1202, 1204 are present, heat produced by the laptop computer 102 is able to escape from the lower portion of the laptop computer 102 and is not trapped. Of course, there is no requirement that the laptop stand 1200 have exactly two apertures or that the apertures be similar in size or shape. In other embodiments, the apertures 1202, 1204 can be slots or any other shape and number.

Further advantages are realized in the form of weight reduction. As stated above, the inventive laptop stand 400 of the present invention is very light weight. However, the provision of the apertures 1202, 1204, or rather, the reduction of material that used to fill the apertures 1202, 1204, reduces the total weight of the laptop stand 400 even further. One produced version of the presently inventive laptop stand 1200 weighed less than 80 gr, which is about 1/25 of the weight of an average laptop.

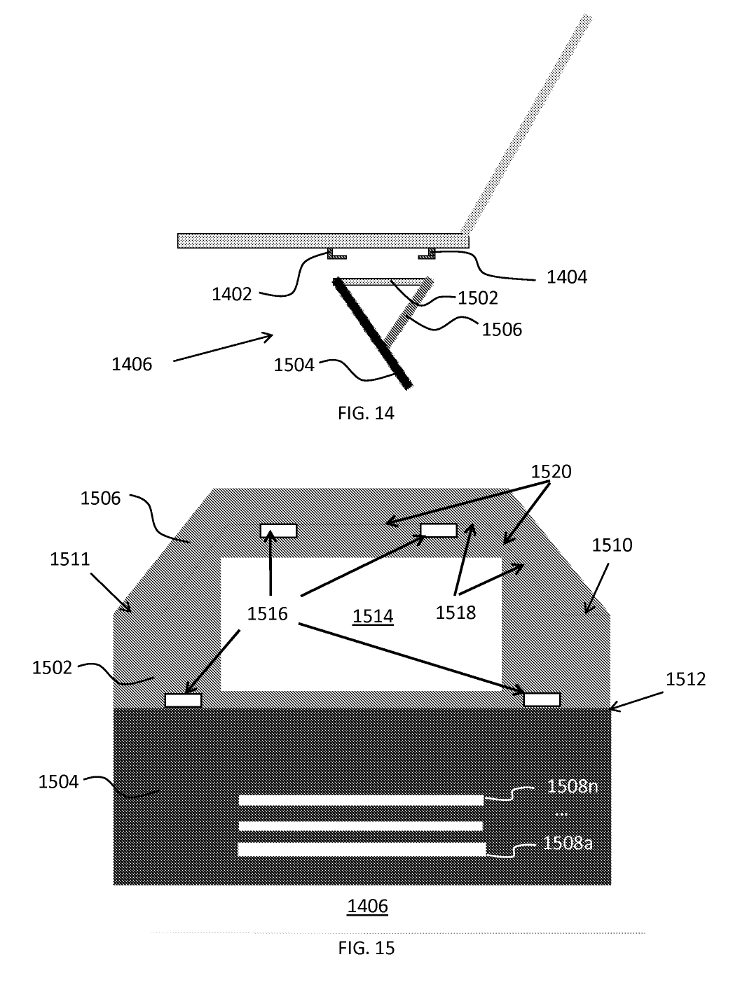

FIG. 14 shows yet another embodiment of the present invention where a pair of shoulders 1402, 1404 are only attached to a portion of the underside surface of the laptop computer 102. As opposed to the previously shown laptop computers 102 with shoulders attached to an underside surface and spread far apart, the shoulders 1402, 1404 are entirely contained within about 50% or less of the total underside surface (from back to front) of the laptop computer 102. In this embodiment, an inventive laptop stand 1406 that has a smaller size than the previously-described laptop stands can be utilized for supporting the laptop computer 102.

FIG. 15 provides further detail of the laptop stand 1406 in accordance with an embodiment of the present invention. The laptop stand 1406 includes a laptop support surface 1502, a support surface angle positioner 1504, and a positioner engagement portion 1506. The laptop support surface 1502 can define one or more apertures 1514 that advantageously reduce the weight of the laptop stand 1500, provide flexibility to the laptop stand 1500, as well as provide ventilation and easy access to features on a bottom surface of the laptop computer. By providing flexibility, the large aperture 1514 allows the laptop support surface 1502 to flex, as shown in FIG. 13, allowing the laptop support surface 1502 to selectively engage the entire laptop stand with the laptop computer case. More specifically, the bent laptop support surface 1502 (due to the aperture 1514) allows the laptop stand 400 to accept the laptop stand securing anchors along the edges of the laptop support surface 1502 in a spring-force biasing manner. As the laptop stand 1406 is shown in FIG. 15, each of the three components, the laptop support surface 1502, the support surface angle positioner 1504, and the positioner engagement portion 1506, all substantially lie in a common plane.

Here, a shape 1518 of the laptop support surface 1502 folds in the concavity of a shape 1520 of the support surface angle positioner 1504. Although the clearance between shape 1518 and 1520 is shown in FIG. 15 as being very close, this matching of the shapes 1518 1520 is not necessary. By allowing the laptop support surface 1502 and the support surface angle positioner 1504 “nest” with each other, the laptop stand 1406 can be provided in a single flat sheet, thereby decreasing the total thickness of the laptop stand 1406. In this configuration, the laptop stand 1406 is flat and compact, which allows it to be stored efficiently below the surface of a laptop computer 102 when not deployed. Although the laptop stand 1406 can be stored flat, it is envisioned that the laptop stand 1406 is able to be folded similar to the laptop stand 400, shown in FIGS. 4-7. That is, the support surface angle positioner 1504 will fold to cover the laptop support surface 1502 and the positioner engagement portion 1506. Magnets or other holding mechanisms can be used to retain this closed/folded position. In addition, this laptop stand embodiment could be formed from a single sheet of material, e.g., ACP.

Any one or all of the elements 1502, 1504, 1506 of the laptop stand 1406 can be an integral part of a laptop case when the case is molded. Alternatively, any one or all of the elements 1502, 1504, 1506 of the laptop stand 1406 can be attached later through an attachment element that can include VELCRO, glue, tape and many others.

According to an embodiment of the present invention, each of the portions, the laptop support surface 1502, the support surface angle positioner 1504, and the positioner engagement portion 1506, meet each other at hinged interfaces. Specifically, a first hinged interface 1510 couples the laptop support surface 1502 to a first side of the positioner engagement portion 1506 and a second hinged interface 1511 couples the laptop support surface 1502 to a second side of the positioner engagement portion 1506. A second hinged interface 1512 couples the laptop support surface 1502 to the support surface angle positioner 1504. Each of the hinged interfaces 1510/1511, 1512 allows one portion to pivot in a different plane from the portion to which it is connected. This is shown in FIG. 14.

FIG. 15 also shows that the laptop support surface 1502 defines one or more apertures 1516. The apertures 1516, according to an embodiment of the present invention, are sized to couple with one or more shoulders or other coupling elements found on a bottom surface of a laptop computer so that the laptop support surface 1502 can be securely and removably coupled to the laptop computer.

With reference once again to FIG. 14, the position and interrelationship of the components of the laptop stand 1406 are shown when the laptop stand 1406 is in its deployed position. More specifically, the hinged interfaces 1510/1511, 1512 are flexed so that each of the main portions, the laptop support surface 1502, the support surface angle positioner 1504, and the positioner engagement portion 1506, are in different planes. For attachment to the laptop computer 102, the laptop support surface 1502 fits between, over, or is otherwise coupled to the shoulders 1402, 1404 and is the element of contact between the laptop computer 102 and the laptop stand 1406. The support surface angle positioner 1504 will make contact with a surface (not shown in this view). Finally, the positioner engagement portion 1506 couples with the support surface angle positioner 1504 at one or more receiver portions 1508a-n (shown in FIG. 15).

It should be noted that the inventive laptop stand 400, 1406, can be attached to a laptop computer in ways that are not shown herein, such as VELCRO, magnets, tape, glue, and others.

In yet a further embodiment, shown in FIG. 17, the inventive laptop stand 1700 is provided with a positioner engagement portion 1706 and a laptop angle positioner 1704, but does not have what was previously referred to as a laptop support surface. In this embodiment, the positioner engagement portion 1706 and the laptop angle positioner 1704 couple directly to the laptop 102, each at one end thereof This embodiment includes attachment of the stand through structures, such as anchors 1402, 1404. Again, the term “anchors,” as used herein, includes bolts, screws, and other structures that can removably coupling the device 1700 to the laptop 102 and are limited to the shapes or structures shown in the figures. A further option is that the positioner engagement portion 1706 and the laptop angle positioner 1704 couple directly to the laptop 102 by permanent hinges.

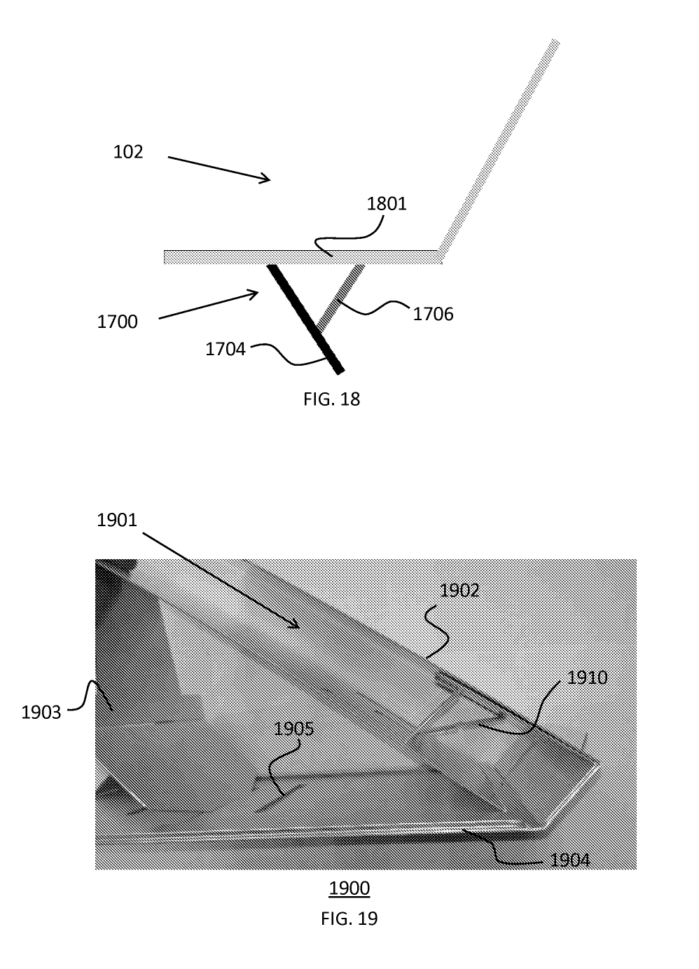

Embodiments of the present invention include, as shown in FIG. 18, permanent coupling, i.e., the laptop stand 1700 is integrated with the case 1801 of the laptop computer 102. The integrated coupling can include a hinged connection, where the positioner engagement portion 1706 and the laptop angle positioner 1704 separate from one another and pivot up and flat against the bottom surface of the laptop 102. In other words, in embodiments where the laptop stand is integrated with the laptop case 1801, the case 1801 becomes one of the structural elements of any of the embodiments described herein. For example, the case 1801 can serve as the laptop support surface 1502 of the laptop stand 1406 shown in FIG. 15, the laptop support surface 1201 of the laptop stand 1200 shown in FIG. 12, or the laptop support surface 401 shown in FIG. 4.

FIGS. 19-21 show a further embodiment of the present invention where the foldable laptop stand 1900 includes a laptop keyboard support area 1901, a document support surface 1902, a support surface angle positioner 1903, and a base 1904. The base 1904 includes a plurality of slots 1905 for engagement with the support surface angle positioner 1903, providing multiple angular positions for the document support surface 1902. The foldable laptop stand 1900 is intended to be used in conjunction with an auxiliary keyboard, as the keyboard of the laptop computer will be within the keyboard support area 1901 and generally not accessible to the user's fingers.

A support member 1910 spans between the keyboard support surface 1906 and the document support surface 1902. When the foldable laptop stand 1900 is fully deployed, the support member 1910 stretches between the keyboard support surface 1906 and the document support surface 1902 and supports the foldable laptop stand 1900 in a deployed position shown in FIG. 19. No known prior-art laptop stands feature a support member that supports the deployed configuration of the laptop stand by being stretched.

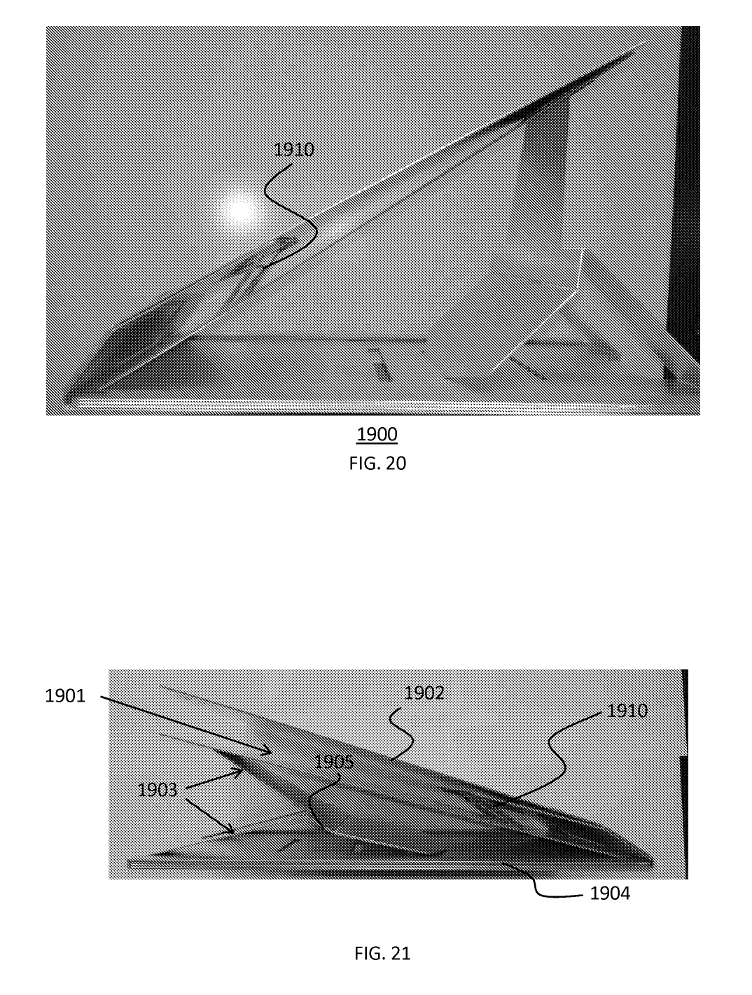

As FIG. 20 shows, an embodiment of the support member 1910 is foldable. In a first stage of folding the foldable laptop stand 1900, the support member 1910 is folded in half, thereby allowing the keyboard support surface 1906 to move toward the document support surface 1902. This step eliminates the laptop keyboard support area 1901.

Although not shown, the support surface angle positioner 1903 also folds allowing the keyboard support surface 1906 and the document support surface 1902 can rotate down and fold parallel to the base 1904.

A foldable laptop stand has been disclosed that is lightweight and easily deployed. The inventive stand can be a separate stand that is attached to a laptop computer each time or can be semi-permanently attached to the laptop computer for quick and convenient deployment.

What is claimed is:

1. A foldable laptop stand comprising:
a laptop support surface having a first portion and a second portion, wherein the first portion and the second portion are non-co-planer;
a support surface angle positioner coupled to and co-planer with the first portion of the laptop support surface; and
a positioner engagement portion coupled to and co-planer with the second portion of the laptop support surface,
wherein:
the support surface angle positioner and the first portion of the laptop support surface have a first hinged interface therebetween;
the positioner engagement portion and the second portion of the laptop support surface have a second hinged interface therebetween; and
the positioner engagement portion is removably coupleable with the support surface angle positioner to selectably position the laptop support surface at an angle to the support surface angle positioner.

2. The laptop stand according to claim 1, wherein:
the support surface angle positioner defines at least one receiving area therein, the at least one receiving area shaped to engage an end of the positioner engagement portion.

3. The laptop stand according to claim 1, wherein:
the first portion and the second portion of the laptop support surface are coupled to each other in a fixed positional relationship.

4. The laptop stand according to claim 1, wherein:
the second portion of the laptop support surface defines at least one aperture shaped to accept a laptop stand securing anchor coupled to a bottom surface of a laptop.

5. The laptop stand according to claim 1, wherein the support surface angle positioner and the first portion of the laptop support surface are comprised of:
a first solid planar layer;
a sheet of flexible material disposed on top of at least a portion of the first solid planar layer; and
a second solid planar layer disposed on an opposing side of the sheet of flexible material as the first solid planar layer.

6. The laptop stand according to claim 5, wherein the first solid planar layer comprises:
a sheet of aluminum.

7. The laptop stand according to claim 5, wherein the flexible material comprises:
a plastic material.

8. The laptop stand according to claim 5, wherein the support surface angle positioner comprises:
ACP.

9. The laptop stand according to claim 5, wherein the first hinged interface comprises:
an exposed area of the flexible material coupled to the support surface angle positioner, the exposed area being of sufficient size to place the flexible material in contact with a supporting surface when at least one of the first hinged interface and the second hinged interface are in a bent configuration.

10. The laptop stand according to claim 1, further comprising:
a first magnet portion coupled to the second portion of the laptop support surface; and
a second magnet portion coupled to the support surface angle positioner, wherein the first magnet portion and the second magnet portion exhibit a magnetic attraction toward one another.

11. The laptop stand according to claim 1, wherein:
at least one of the first hinged interface and the second hinged interface is a living hinge.

12. A configurable laptop stand for use with a laptop computer having an outer case, the laptop stand comprising:
at least one laptop-stand anchor coupled to an underside of the outer case of the laptop computer;
a laptop support surface defining at least one aperture shaped to selectively engage the laptop stand with the laptop computer case;
a laptop angle positioner hingedly coupled to the laptop support surface;
a positioner engagement portion hingedly coupled to the laptop support surface; and
a laptop angle positioner securing mechanism operable to bias the laptop angle positioner in a position parallel to the laptop support surface.

13. The laptop stand according to claim 12, wherein the laptop support surface and the laptop angle positioner comprises:
a pair of opposing planar surfaces; and
a flexible material disposed between the pair of opposing planar surfaces.

14. The laptop stand according to claim 12, wherein the laptop support surface and the laptop angle positioner comprises:
ACP material.

15. The laptop stand according to claim 12, wherein the laptop support surface comprises:
a first support portion and a second support portion, wherein the first support portion and the second support portion are non-co-planer.

16. The laptop stand according to claim 15, wherein:
the first support portion and the second support portion are coupled to each other in a fixed-position parallel relationship.

17. The laptop stand according to claim 12, wherein the at least one aperture comprises;
a first portion having a first dimension; and
a second portion coupled to the first portion and having a second dimension corresponding to the first dimension of the first portion, the second dimension of the second portion being larger than the first dimension of the first portion.

18. A configurable laptop stand for use with a laptop computer having a keyboard and an outer case, the laptop stand comprising:
at least one laptop-stand anchor at a surface of an outer case of the laptop computer;
a laptop angle positioner defining at least one aperture shaped to selectively engage with the at least one laptop-stand anchor; and
a positioner engagement portion defining at least one aperture shaped to selectively engage with the at least one laptop-stand anchor,
wherein the positioner engagement portion is removably coupleable with the laptop angle positioner to selectably position the laptop angle positioner at an angle to the positioner engagement portion.

19. The laptop stand according to claim 18, further comprising:
a laptop angle positioner securing member operable to secure the laptop angle positioner in a position that is parallel to a surface of a laptop keyboard.

20. The laptop stand according to claim 19, wherein:
the laptop angle positioner securing member is operable to bias the positioner engagement portion in a position that is parallel to the laptop keyboard portion.
